(19) United States
(12) Patent Application Publication
(10) Pub. No.: US 2017/0103657 A1
(43) Pub. Date: Apr. 13, 2017

(54) DRIVE ASSIST APPARATUS AND STORAGE MEDIUM STORING PROGRAM FOR EXECUTING DRIVE ASSIST PROCESS

(71) Applicant: DENSO CORPORATION, Kariya-city (JP)

(72) Inventor: Jian Hu, Kariya-city, Aichi-pref. (JP)

(21) Appl. No.: 15/284,998

(22) Filed: Oct. 4, 2016

(30) Foreign Application Priority Data
Oct. 8, 2015 (JP) 2015-200141

(51) Int. Cl. G08G 1/16; G01S 19/42; G06T 7/00; B60Q 9/00; G06K 9/00; B60R 11/04; B62D 1/28

(52) U.S. Cl. CPC G08G 1/167; B60R 11/04; G01S 19/42; B62D 1/28; B60Q 9/008; G06K 9/00798; G06T 7/0044

(57) ABSTRACT

A drive assist apparatus includes a propriety decision section that decides whether or not an object vehicle to be controlled will be able to pass a preceding vehicle while keeping traffic regulations, a maneuver detecting section that detects whether or not a passing maneuver to pass the preceding vehicle has been started, and a warning section that gives a warning to a vehicle driver of the object vehicle at a time when the propriety decision section decides that the object vehicle to be controlled will not be able to pass the preceding vehicle while keeping the traffic regulations, and the maneuver detecting section detects that the passing maneuver has been started.

This application claims priority to Japanese Patent Application No. 2015-200141 filed on Oct. 8, 2015, the entire contents of which are hereby incorporated by reference.

### BACKGROUND OF THE INVENTION

1. Field of the Invention

The present invention relates to a drive assist apparatus and a storage medium storing a drive assist program.

2. Description of Related Art

There is known a technique for determining whether an object vehicle to be controlled can pass a preceding vehicle when a vehicle driver of the object vehicle shows an intention to pass the preceding vehicle. For example, Japanese Patent Application Laid-open No. 2008-90654 describes an apparatus which sets a target speed to pass a preceding vehicle based on the speed of the preceding vehicle when a vehicle driver has made a passing maneuver. This apparatus notifies the vehicle driver that it will not be possible to pass the preceding vehicle if the set speed is higher than a speed limit specified by the road traffic regulation.

However, the above described apparatus has a problem in that timing to notify the vehicle driver may not be appropriate for some situations. For example, in a case where an object vehicle is running on a one-lane road, it may occur that the apparatus notifies the vehicle driver that it is not possible to overtake the preceding vehicle after the preceding vehicle strayed into the opposite lane.

### SUMMARY

An exemplary embodiment provides a drive assist apparatus including:

a propriety decision section that decides whether or not an object vehicle to be controlled will be able to pass a preceding vehicle while keeping traffic regulations;

a maneuver detecting section that detects whether or not a passing maneuver to pass the preceding vehicle has been started; and

a warning section that gives a warning to a vehicle driver of the object vehicle at a time when the propriety decision section decides that the object vehicle to be controlled will not be able to pass the preceding vehicle while keeping the traffic regulations, and the maneuver detecting section detects that the passing maneuver has been started.

The exemplary embodiment also provides a storage medium storing a program causing a computer to execute a drive assist process including deciding whether or not an object vehicle to be controlled will be able to pass a preceding vehicle while keeping traffic regulations, detecting whether or not a passing maneuver to pass the preceding vehicle has been started, and giving a warning to a vehicle driver of the object vehicle if a decision that the object vehicle will not be able to pass the preceding vehicle while keeping the traffic regulations is made, and a detection that the passing maneuver has been started is made.

According to the exemplary embodiment, there is provided a drive assist apparatus and a drive assist process which enable giving a warning that it will not be possible to pass a preceding vehicle while keeping traffic regulations to a vehicle driver at an appropriate timing.

Other advantages and features of the invention will become apparent from the following description including the drawings and claims.

### BRIEF DESCRIPTION OF THE DRAWINGS

In the accompanying drawings:

FIG. 1 is a block diagram showing the structure of a drive assist apparatus according to a first embodiment of the invention;

FIG. 2 is a flowchart showing steps of a drive assist process performed by the drive assist apparatus; and

FIG. 3 is a diagram for explaining advantages of the drive assist process.

### PREFERRED EMBODIMENTS OF THE INVENTION

### First Embodiment

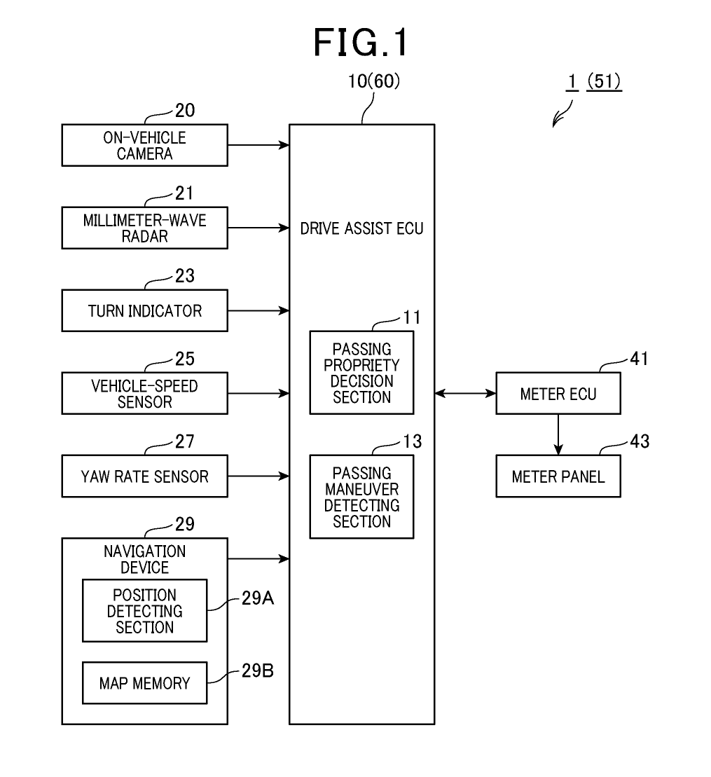

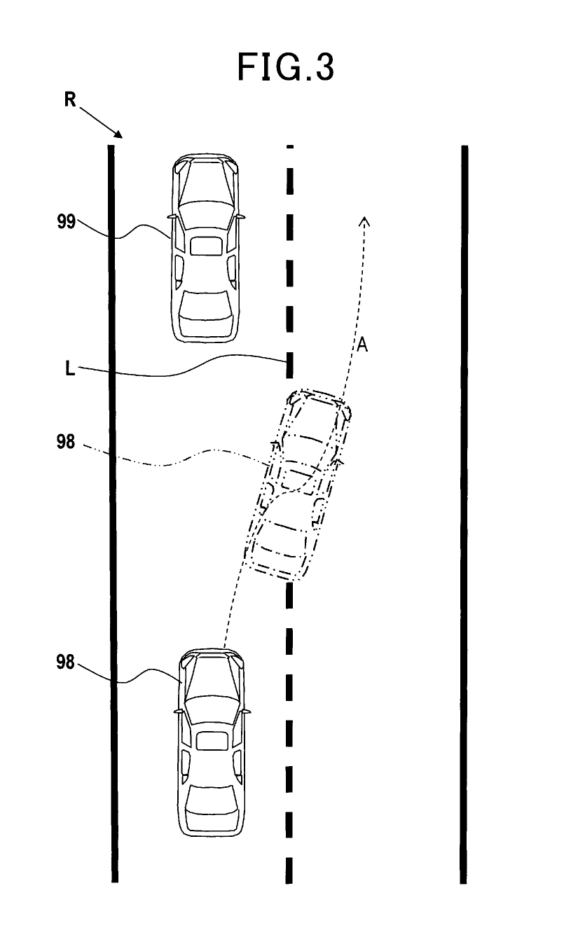

FIG. 1 is a block diagram showing the structure of a drive assist apparatus 1 according to a first embodiment of the invention. The drive assist apparatus 1, which is mounted on an object vehicle 98 to be controlled shown in FIG. 3, is mainly consisted of a drive assist ECU 10. The drive assist ECU 10 is connected with an on-vehicle camera 20, a millimeter-wave radar 21, turn indicators 23, a vehicle speed sensor 25, a yaw rate sensor 27, a navigation device 29, a meter ECU 41 and so on.

The on-vehicle camera 20 is for capturing images ahead of the object vehicle 98. The millimeter-wave radar 21 is for detecting the distance to a preceding vehicle or an obstacle present ahead of the object vehicle 98. The turn indicators are lit by a vehicle driver of the object vehicle 98 at the time of lane changing, overtaking, turning left or right, and so on. The vehicle speed sensor 25 is for detecting the speed of the object vehicle 98. The yaw rate sensor 27 is for detecting the turning angle velocity of the object vehicle 98.

The navigation device 29 includes a position detecting section 29A and a map memory 29B. The position detecting section 29A is for detecting the latitude and the longitude of the current position of the object vehicle 98. The position detecting section 29A may be a GPS (Global Positioning System) or GNSS (Global Navigation Satellite System). In the map memory 29B, there are stored various regulatory information including speed limits and passing prohibition/permission in addition to general map data of a road map.

The meter ECU 41 performs display control of a meter panel 43 provided in front of the driver's seat. The meter panel 43 is for displaying the vehicle speed and other various information in accordance with signals supplied from the meter ECU 41.

The drive assist ECU 10 is a microcomputer-based ECU having a CPU and semiconductor memories including a RAM, a ROM and a flash memory. Various functions or methods of the drive assist ECU 10 are implemented by the CPU executing programs stored in the semiconductor memories which are non-transitory physical storage medium. The drive assist ECU 10 may include one or two or more CPUs.

The drive assist ECU 10 includes a passing propriety decision section 11 and a passing maneuver detecting section detection section 13 as its functions. These functions do not necessary have to be implemented by software. All or part of them may be implemented by hardware including combinations of logical circuits and analog circuits.

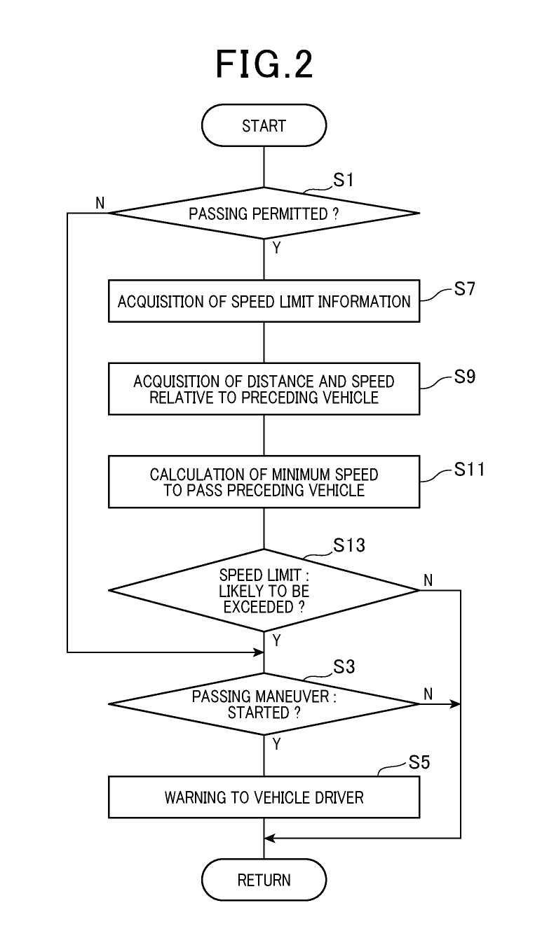

Next, a drive assist process performed by the drive assist ECU 10 is explained with reference to the flowchart of FIG. 2. When either one of the turn indicators 23 is lit, the drive assist ECU 10 starts to perform the drive assist process.

As shown in FIG. 2, this process begins in step S1 where it is detected whether or not the current road (the road on which the object vehicle 98 is running) is a passing permitted road. Step S1 is performed by the passing propriety decision section 11 based on results of analyzing images captured by the on-vehicle camera 20. The position detecting section 29A and the map memory 29B of the navigation device 29 may be used to assist performing step S1.

If the detection result in step S1 is negative, the process proceeds to step S3. In step S3, it is detected whether or not the object vehicle 98 has started a passing maneuver to pass a preceding vehicle 99 shown in FIG. 3. In this embodiment, it is detected that the passing maneuver has been started if the turn indicator 23 is being lit over a predetermined time, and the relative speed between the object vehicle 98 and the preceding vehicle 99 is lower than a predetermined threshold speed.

Here, the relative speed is the speed of the preceding vehicle 99 minus the speed of the object vehicle (own vehicle) 98. The relative speed can be acquired by the millimeter-wave radar 21. The threshold speed may be set to −5 km/h. Step S3 is performed by the passing maneuver detecting section 13.

If the detection result in step S3 is negative, the process is terminated. On the other hand, if the detection result in step S3 is affirmative, the process proceeds to step S5. In step S5, the meter panel 43 displays a warning message in accordance with a signal received from the meter ECU 41, and then the process is terminated. The warning message may be just “PASSING PROHIBITED”, or may be accompanied with a message stating that the current road section is a passing prohibited section. Further, this message may be notified by a not shown speaker.

If the detection result in step S1 is affirmative, the process proceeds to step S7. In step S7, speed limit information of the current road is acquired by analyzing images captured by the on-vehicle camera 20. The position detecting section 29A and the map memory 29B of the navigation device 2 may be used to assist performing step S7. In subsequent step S9, the relative speed is acquired by the millimeter-wave radar 21. In subsequent step S11, a minimum speed necessary for the object vehicle 98 to pass the preceding vehicle 98 is calculated. In this embodiment, the minimum speed is calculated by adding a predetermined speed to the sum of the speed of the object vehicle 98 acquired by the vehicle speed sensor 25 and the relative speed. In subsequent step S13, it is determined whether or not the speed of the object vehicle 98 will be likely to exceed the speed limit by comparing the calculated minimum speed with the speed limit acquired in step S7. Step S17 is performed by the passing propriety decision section 11.

If the determination result in step S13 is negative, the process is terminated, and otherwise the process proceeds to step S3. In step S3, it is detected whether the object vehicle has started a passing maneuver based on the relative speed acquired in step S9. If the detection result in step S3, the process proceeds to step S5. In step S5, a warning message is displayed. The message may be just “PASSING PROHIBITED”, or may be accompanied with a message that the speed will exceed the speed limit.

The embodiment described above provides the following advantages. If it is determined in steps S1 or S13 that the object vehicle 98 will not be able to pass the preceding vehicle 99 while keeping the regulation, and the object vehicle 98 has started a passing maneuver, a warning is given to the vehicle driver. That is, according to the embodiment, a warning is given to the vehicle driver at a timing when the vehicle driver starts performing an operation for the object vehicle 98 to pass the preceding vehicle 98. As described above, according to the embodiment, it is possible to appropriately set a timing to issue a warning that the object vehicle 98 will not be able to pass the preceding vehicle 99 while keeping the regulation.

Here, consider a case where the object vehicle 98 runs on a one-lane road R with a white dashed center line L (while line L hereinafter). Assume that the object vehicle 98 moves relative to the preceding vehicle 99 along the arrow A in FIG. 3 to pass the preceding vehicle 99. In this case, if a warning is issued after the object vehicle 98 crossed the white line L into the opposite lane, the vehicle driver may be confused. According to the embodiment, a warning is issued at a time when the object vehicle 98 starts to move relative to the preceding vehicle 99 along the arrow A at a relative speed lower than or equal to −5 km/h. That is, the warning is issued immediately after the vehicle driver starts to perform a passing maneuver so that the vehicle driver can drive the object vehicle 98 safely and comfortably.

According to the embodiment, it is determined in step S1 or S13 whether or not the object vehicle 98 will be able to pass the preceding vehicle 99 while keeping the regulation irrespective of whether a passing maneuver to pass the preceding vehicle 99 has been started or not. If it is determined in step S1 or S13 that the object vehicle 98 will not be able to pass the preceding vehicle 99 while keeping the regulation, it is detected in step S3 whether or not a passing maneuver has been started. Accordingly, a warning is issued at a more appropriate timing immediately after the vehicle driver starts to perform a passing maneuver so that the vehicle driver can drive the object vehicle 98 more safely and comfortably.

According to the embodiment, it is determined both whether or not the current road is a passing permitted road and whether or not the vehicle speed will be likely to exceed the limit speed. Accordingly, the embodiment described above provides an advantage to prevent the vehicle driver from violating the no-passing regulation and an advantage to prevent the vehicle driver from violating the speed limit regulation.

According to the embodiment, regulatory information such as prohibition or permission of passing a preceding vehicle and a limit speed is acquired through images captured by the on-vehicle camera 20. This makes it possible to properly comply with regulatory information.

### Second Embodiment

Next, a drive assist apparatus 51 according to a second embodiment of the invention is described with a focus on differences with the first embodiment. The second embodiment is basically the same in mechanical structure as the first embodiment shown in FIG. 1. The drive assist apparatus 51 according to the second embodiment includes a drive assist ECU 60 instead of the drive ECU 10.

A drive assist process performed by the drive assist ECU 60 differs from the drive assist process performed by the drive ECU 10 in the content of step S3. In the second embodiment, it is determined in step S3 that the object vehicle 98 has started a passing maneuver at a time when a part of the body of the object vehicle 98 has been detected to have crossed the white line L based on images captured by the on-vehicle camera 20.

The second embodiment provides the following advantage in addition to the advantages provided by the first embodiment.

In the second embodiment, determination of whether a passing maneuver has been started may be made even when there is no change in the speed of the object vehicle 98. Therefore, according to the second embodiment, it is possible to determine at an appropriate timing that a passing maneuver has been started even in a case where the vehicle driver moves the object vehicle 98 toward the opposite lane to confirm whether there is a space ahead of the preceding vehicle 99 for the object vehicle 98 to enter, and then accelerates the object vehicle 98 to pass the preceding vehicle 98. In this case, since a warning is issued while the vehicle driver makes the confirmation, the vehicle driver can drive the object vehicle even more safely. On the other hand, in a case where the vehicle driver makes such a confirmation after the vehicle driver causes the object vehicle 98 to catch up with the preceding vehicle 99, a warning is issued at an earlier timing and the vehicle driver can drive the object vehicle 98 more safely according to the first embodiment than according to the second embodiment.

### Modification of the Second Embodiment

The content of step S3 may be modified differently from that in the second embodiment described above. For example, the relative position of the object vehicle 98 in the vehicle width direction relative to the preceding vehicle 99 may be detected by the on-vehicle camera 20. In this case, it can be determined that a passing maneuver has been started at a moment when the object vehicle 98 has been detected to have moved in the vehicle width direction by over a predetermined value.

### Other Embodiments

It is a matter of course that various modifications can be made to the above described embodiments of the invention as described below.

In the first embodiment, various traffic regulation information such as speed limit and prohibition/permission of passing are acquired basically through images captured by the on-vehicle camera 20. However, such traffic regulation information may be acquired using only the position detecting section 29A and the map memory 29B of the navigation device 29A. In this case, traffic regulation information stored in the map memory 29B are used. Further, the first embodiment may be modified such that part of the traffic regulation information are acquired through captured images, and the other part of the traffic regulation information are acquired from the map memory 29B. In the case where all the traffic regulation information are acquired through images captured by the on-vehicle camera 20, the navigation device 29 may be omitted. When the present invention is used for special vehicles, the limit speed may be fixed to a constant value.

In the above embodiments, the speed of the preceding vehicle 99 is indirectly detected based on the relative speed of the object vehicle 98 relative to the preceding vehicle 99 and the speed of the object vehicle 99, and then a minimum speed necessary to pass the preceding vehicle 99 is calculated based on the detected speed of the preceding vehicle 99. However, the speed of the preceding vehicle 99 may be directly detected by comparing an image of the while line L and an image of the preceding vehicle 99 captured by the on-vehicle camera 20.

In the above embodiments, the passing propriety decision section 11 is configured to determine whether the road on which the object vehicle 98 is running is a passing permitted road and determine whether the speed of the object vehicle 98 will be likely to exceed a limit speed when passing a preceding vehicle. However, the passing propriety decision section 11 may be configured differently, if it can determine whether or not the object vehicle will be able to pass a preceding vehicle while keeping the regulation. For example, the passing propriety decision section 11 may be configured to determine one of whether or not the road on which the object vehicle 98 is running is a passing permitted road and whether or not the speed of the object vehicle 98 will be likely to exceed a speed limit when passing a preceding vehicle.

In the above, the words “passing a preceding vehicle” means that the object vehicle moves ahead of a preceding vehicle and thereafter the object vehicle may or may not return to the original lane.

In the above embodiments, the passing maneuver detecting section 13 detects travelling states of the object vehicle 98 such as the approaching speed of the object vehicle 98 to the preceding vehicle 99, the position of the object vehicle 98 relative to the while line L or the relative position in the vehicle width direction of the object vehicle 98 relative to the preceding vehicle 99 to detect start of a passing maneuver. Start of a passing maneuver may be detected based on combinations of these travelling states. The passing maneuver detecting section 13 may detect start of a passing maneuver using other than the above travelling states of the object vehicle 98, For example, start of a passing maneuver may be detected by comparing the yaw rate of the object vehicle 98 detected by the yaw rate sensor 27 with a road curvature of the current road.

In the above embodiments, a warning that passing will not be possible is given to the vehicle driver by displaying a message on the meter panel 43. However, such a warning may be given to the vehicle driver in various forms. For example, a sound generating device such as a bell or a buzzer may be used. For another example, a liquid crystal display of the navigation device 29 may be used. Further, a device for applying vibration to the driver's seat may be used.

In the above embodiments, the components of the drive assist apparatus 1 are vehicle-mounted components. However, the components of the drive assist apparatus 1 may be components included in a smartphone or the like carried by the vehicle driver and a cloud computer outside the object vehicle 98. In this case, the various functions of the drive assist apparatus 1 are implemented by the cloud computer to which images ahead of the object vehicle 98 captured by the smartphone and the position information of the object vehicle 98 detected by the smartphopne are transmitted, and the smartphone gives a warning to the vehicle driver by image or sound.

The drive assist apparatus of the present invention and a system including this drive assist apparatus may be practiced using computer programs and a non-transitory physical storage medium.

The above explained preferred embodiments are exemplary of the invention of the present application which is described solely by the claims appended below. It should be understood that modifications of the preferred embodiments may be made as would occur to one of skill in the art.

What is claimed is:

1. A drive assist apparatus comprising:
a propriety decision section that decides whether or not an object vehicle to be controlled will be able to pass a preceding vehicle while keeping traffic regulations;
a maneuver detecting section that detects whether or not a passing maneuver to pass the preceding vehicle has been started; and
a warning section that gives a warning to a vehicle driver of the object vehicle at a time when the propriety decision section decides that the object vehicle to be controlled will not be able to pass the preceding vehicle while keeping the traffic regulations, and the maneuver detecting section detects that the passing maneuver has been started.

2. The drive assist apparatus according to claim 1, further comprising a speed detecting section for directly or indirectly detecting a vehicle speed of the preceding vehicle,
the propriety decision section being configured to determine whether or not the object vehicle will be able to pass the preceding vehicle without exceeding a limit speed based on the vehicle speed of the preceding vehicle detected by the speed detecting section.

3. The drive assist apparatus according to claim 1, further comprising a camera for capturing an image ahead of the object vehicle,
the propriety decision section being configured to determine whether or not a road on which the object vehicle is running is a passing permitted road.

4. The drive assist apparatus according to claim 1, wherein the maneuver detecting section detects that the passing maneuver has been started if an approaching speed of the object vehicle to the preceding vehicle is higher than a predetermined speed and a turn indicator of the object vehicle is in operation.

5. The drive assist apparatus according to claim 1, further comprising a white line detecting section for detecting a relative position of the object vehicle relative to a white line on a surface of a road on which the object vehicle is running,
the maneuver detecting section being configured to detect that the passing maneuver has been started upon detecting that the object vehicle has crossed the white line based on a detection result of the white line detecting section.

6. The drive assist apparatus according to claim 1, further comprising a lateral position detecting section for detecting a relative position of the object vehicle in a vehicle width direction relative to the preceding vehicle,
the maneuver detecting section being configured to detect that the passing maneuver has been started upon detecting that the object vehicle has moved in the vehicle width direction by more than a predetermined amount based on a detection result of the lateral position detecting section.

7. The drive assist apparatus according to claim 1, wherein
the propriety decision section decides whether or not the object vehicle will be able to pass the preceding vehicle irrespective of whether or not the maneuver detecting section detects that the passing maneuver has been started, and
the maneuver detecting section detects whether or not the passing maneuver has been started if the propriety decision section decides that the object vehicle will be able to pass the preceding vehicle.

8. A storage medium storing a program causing a computer to execute a drive assist process including deciding whether or not an object vehicle to be controlled will be able to pass a preceding vehicle while keeping traffic regulations, detecting whether or not a passing maneuver to pass the preceding vehicle has been started, and giving a warning to a vehicle driver of the object vehicle if a decision that the object vehicle will not be able to pass the preceding vehicle while keeping the traffic regulations is made, and a detection that the passing maneuver has been started is made.
